(19) United States
(12) Patent Application Publication
(10) Pub. No.: US 2009/0109885 A1
(43) Pub. Date: Apr. 30, 2009

(54) Method and Apparatus for Reducing Energy Consumption in Nodes by Adjusting Carrier Sensing Thresholds

(75) Inventors: Benedito J. Fonseca, JR., Glen Ellyn, IL (US); King F. Lee, Schaumburg, IL (US); Michael Masquelier, Barrington, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/926,780

(22) Filed: Oct. 29, 2007

(51) Int. Cl. G08C 17/00; H04Q 7/20

(52) U.S. Cl. 370/311; 370/400; 455/522

(57) ABSTRACT

Energy consumption in a network is reduced by a first node transmitting a message at a first power level and determining if the message is received by a neighboring node of the network. The message is retransmitted at a higher power level if the message is not received by a neighboring node. A second node, in a neighborhood of the first node, selects one of two or more receiver sensitivity levels and senses the received signal strength of the message. The second node activates an energy-consuming functional element to decode the first message only if the received signal is above the selected receiver sensitivity level. The receiver sensitivity levels are selected in accordance with a selection process, such as a random process, that may be adapted.

### BACKGROUND

In a wireless ad hoc network, such as a sensor network or a mobile ad hoc network, a node or sensor wanting to transmit an information packet must find a route to the packet's destination. This discovery process involves actions by multiple nodes in the network, even though transmission of the packet (decoding and/or forwarding) could have been handled by a single node. As result, excessive energy is consumed in the network.

For example, a traditional ad hoc network or wireless sensor network includes a number of battery-powered nodes, which may be mobile. If a reactive routing algorithm is used whenever a node has to transmit a packet, the node must find a route to the destination. In reactive algorithms, the process of finding a route involves the broadcast of a route request message (RREQ) in the node's neighborhood. Nodes receiving a RREQ rebroadcast the RREQ until it arrives at the final destination (the sink node). Thus, multiple nodes have decoded and forwarded the RREQ message, even though the final route would contain a single node.

As a further example, some wireless sensor networks include battery-powered sensors that are stationary and a sink node that moves. In this example, sensors cannot rely on fixed routes to reach the sink node. Assuming that the packet generation rate at the sensors (which may be related to an event rate) is small compared to the mobility of the sink node, it is inefficient, in terms of energy usage, to proactively discover routes to the sink node. Thus, sensors would have to discover a route before or while transmitting a packet to the sink node and the same route discovery process as described in the first example above would be necessary. Alternatively, if the information being sent by the node is short enough to fit in a packet, the sensor would simply broadcast the information packet addressed to the sink node. Nevertheless, the packet must again be decoded by multiple neighboring sensors and relayed until it reaches the sink node. In other words, multiple nodes will have to decode and forward the information packet, even though a single node could have forwarded it to the sink node.

A still further example is a traditional wireless sensor network (WSN), in which the sink node and a set of battery-powered sensors are stationary. At the time of deployment, sensors are able to self-organize themselves and each sensor is able to identify one or more neighboring sensors that represent the first hop toward the sink node. The sensors may self-organize to form a communication schedule in which potential transmitters and receivers can transmit in orthogonal periods of time. In other words, any sensor that is a hop in a route between the sink node and another sensor would wake up and be ready to receive messages in specific time-slots. If sensors can fail, and if the time to repair a failed sensor is long, a sensor must determine multiple neighboring sensors that can forward packets to the fusion center (the sink node). As a result, these neighboring sensors must become active (wake up) during the times allocated for the sensor's transmission and be ready to receive and decode packets, so as to determine whether they are destination nodes or not. For example, a sensor S1 may determine that sensors S2, S3 and S4 are potential sensors that can forward packets to the fusion center. A time-slot would be allocated for node S1's transmission and all nodes S2, S3 and S4 would have to wake up and listen for node S1's transmission in the allocated time-slot. In other words, in a static situation, there are multiple sensors decoding the information packet, even though just one of them could have decoded it.

In all of the above examples, there is a node transmitting a packet that is treated by multiple neighboring nodes, even though one neighboring nodes would be sufficient to successfully forward the packet to the sink node.

In the first two examples the problem is more serious since multiple nodes consume energy not only to decode the packet, but also to forward it towards the sink node. However, the problem is also important for the last example if the energy to decode a packet is significantly larger than the energy to simply measure the energy present on the channel. For example, packet decoding may require operation of a digital signal processor (DSP), while energy detection can be performed with the DSP in a deep-sleep state, during which its energy consumption is very low.

Changing the carrier sensing threshold of nodes in a mobile ad hoc network has been proposed as a way to increase the data throughput of a multi-hop ad hoc network. However, these techniques do not provide energy conservation during route discovery procedures.

It is known that power consumption in a network may be reduced by reducing the power of the transmitted signal, as shown in FIG. 1 and FIG. 2. FIG. 1 and FIG. 2 show diagrammatic representations of an exemplary network comprising a number of nodes. In FIG. 1, a message from a transmitting node ‘T’ (102) is received and decoded by receiving nodes ‘R’ (104) within a neighborhood 106 of the transmitting node 102. The received signal strength at node 108 outside of the neighborhood 106 is such that these nodes do not receive the signal. One method of reducing power consumption is to reduce the power level of transmitted signals. FIG. 2 shows the same network configuration as in FIG. 1, except that the power level of transmitting node ‘T’ (102) is reduced compared to the power level in FIG. 2. The number of receiving nodes ‘R’ (104) in the neighborhood 202 is reduced and nodes 204 are now outside of the neighborhood 202 and do not receive the signal. However, since the size of the neighborhood 202 is reduced compared with neighborhood 106, the hop range of the network is reduced and more hops may be required for a message to reach its destination.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of an exemplary network comprising a number of nodes and including in a high power transmitting node.

FIG. 2 is a diagrammatic representation of an exemplary network comprising a number of nodes and including in a low power transmitting node.

FIG. 3 is a flow chart of a method in accordance with some embodiments of the invention.

FIG. 4 is a diagrammatic representation of an exemplary network comprising a number of nodes in accordance with some embodiments of the present invention.

FIG. 5 is a block diagram of an exemplary network node in accordance with some embodiments of the present invention.

FIG. 6 and FIG. 7 are graphs showing the energy reduction benefit of an embodiment of the invention.

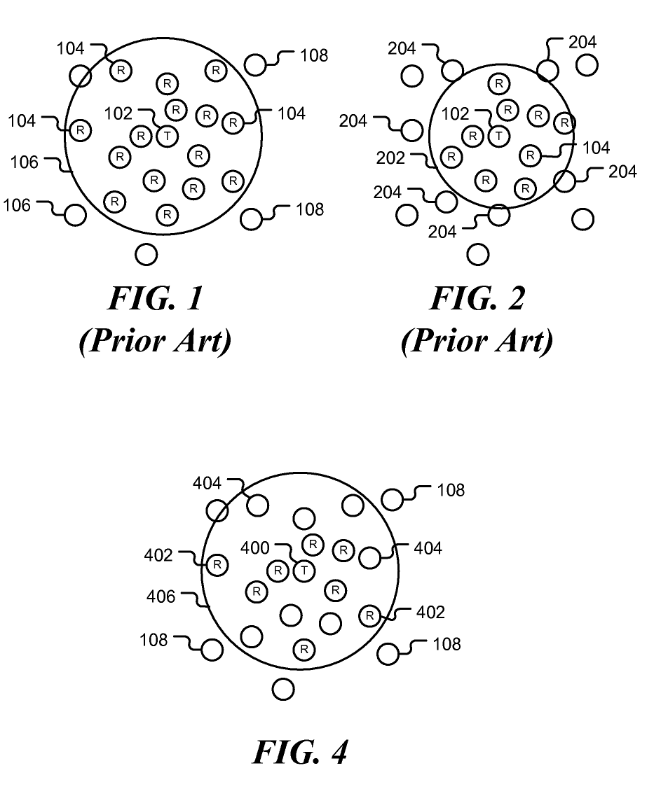

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the reduction of energy consumption in a network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions of network energy reduction described herein. The non-processor circuits may include, but are not limited to, a radio receiver, a radio transmitter, signal drivers, clock circuits, power source circuits, and user input devices. As such, these functions may be interpreted as a method to reduce energy consumption in a network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

One embodiment of the present invention relates to a method in which sensor nodes in a wireless sensor network (WSN) alternate between different sensitivity levels in order to avoid multiple sensors forwarding the same measurement. Sensor nodes coordinate among nearby sensors such that there is a high chance that at least one of the sensors in an area uses a larger sensitivity level in order to ensure connectivity. Transmitting nodes also switch between two or more transmit power levels, so as to minimize the chance of loss of connectivity.

The method can be applied in many different wireless sensor network (WSN) settings and more generally in other wireless networks having one of more mobile nodes. However, an exemplary embodiment is described below in which the network comprises a single-channel WSN in which sensors need multi-hop communications in order to transmit a packet to the sink node. In this embodiment, sensor nodes are either “active” or “inactive”. An active sensor is a sensor that has measurement data or other information ready to send to the sink node. If a sensor is not active, it is inactive. Inactive sensor nodes sleep (i.e. operate in a very low power consumption mode) most of the time but periodically wake up (enter a higher power consumption state) to determine whether any active sensor needs to transmit a message. In this example, it is assumed that all sensors wake up synchronously; although the method of the invention may be used in the non-synchronized case as well. Nodes can wake up and go back to sleep at non-synchronized random times. However, a higher node density may be required to maintain connectivity.

Whenever an inactive node wakes up, it turns on its receiver and measures the received signal strength indicator (RSSI) level. If the level is above a carrier sense threshold, the node tries to decode the packet (and subsequently forward it). Otherwise, the node doesn't activate the decoding portion of its circuitry. Generally, decoding a packet requires additional energy consumption.

Although sensors move, it is assumed in this embodiment that the density of sensors is kept approximately constant in the area being monitored.

Sensors have two or more levels of carrier sense threshold (high and low, for example) and two or more levels of transmit power (again, high and low, for example). The levels, and node density, are set such that the probability that a sensor, having a “low” sensitivity level, is able to decode a packet transmitted with the “low” transmit power is much smaller than the probability of decoding a packet transmitted with the “high” transmit power level. Also, it is assumed that the probability that a sensor at the “high” sensitivity level is able to decode a packet transmitted at “low” transmit power is high.

While the sensor node is actually able to decode transmit packets in both sensitivity levels, in the “low” sensitivity level, the node only activates its decoding circuitry if the received signal strength indicator (RSSI) level is above a certain threshold. This threshold is higher than the threshold in the “high” sensitivity level.

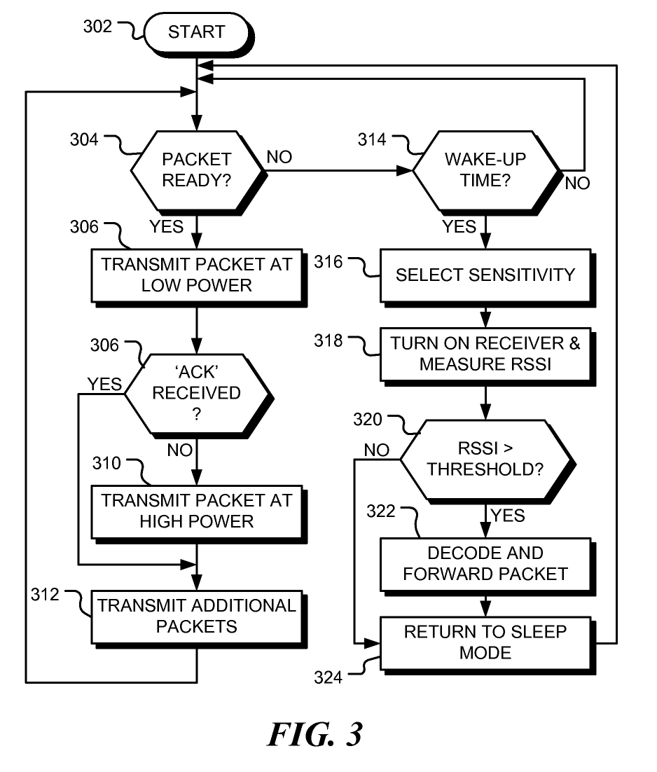

FIG. 3 is a flow chart of a method in accordance with some embodiments of the invention. Following start block 302 in FIG. 3, at decision block 304 a node of a network checks if a new information packet is ready to be transmitted. If a new information packet is ready to be transmitted, as depicted by the positive branch from decision block 304, the node transmits a packet (which may be an information packet, a route request (RRQ) message, or a combination of these) at low power at block 306. Optionally, the RRQ message may include some, or all, of the information to be transmitted. At decision block 308 the node determines if the packet has been received by a neighboring node. This may be done by listening for an acknowledgement (ACK) message, for example. If no acknowledgement is received after a specified number of attempts, as depicted by the negative branch from decision block 308, the packet is retransmitted at a higher power level at block 310. Assuming an acknowledgement is then received, any additional packets are transmitted, at the same power level, at block 312. If no acknowledgement is received, the node may repeat transmission of the packet periodically. Once the packet has been sent, flow returns to block 304. Alternatively, at block 308, the node determines if the packet has been received by a neighboring node by momentarily maintaining its receiver turned on at a high sensitivity level and monitoring whether its packet was forwarded by any node. Given that nodes' antennas are omni-directional, if a node 600 transmits a packet 700 that is received by node 601, when node 601 forwards the packet 700 towards the sink, node 600 would be able to receive, decode node 601's transmission and determine that packet 700 was successfully forwarded.

If the are no packets to be sent, as depicted by the negative branch from decision block 304, a check is made at decision block 314 to determine if it is time for the node to wake up. The wake up time may be scheduled or random and may or may not be synchronized with other nodes. If it is not time for the node to wake up, as depicted by the negative branch from decision block 314, flow returns to block 304. Otherwise, as depicted by the positive branch from decision block 314, the node selects a receive sensitivity at block 316. The sensitivity may be a signal strength threshold, for example, or a receiver gain that affects the signal strength. Using a lower gain may reduce power consumption still more. The threshold (or, equivalently, the gain) may be selected from two or more thresholds. The threshold selection may be made using a probability model or in accordance with a schedule. At block 318, the node turns on its receiver and measures the current received signal strength indicator (RSSI) (or some other measure of carrier power). If the RSSI is greater than the selected threshold, as depicted by the positive branch from decision block 320, the incoming packet is decoded and, if necessary, forwarded at block 322 to a network address decoded from the incoming packet. The node then returns to sleep mode at block 324 and flow returns to block 304. Similarly, if the RSSI is below the selected threshold, as depicted by the negative branch from decision block 320, flow continues to block 322 and the node returns to sleep mode.

In general, a received packet will be decoded unless the transmitting node is transmitting at a low power level and the receiving node is receiving at a low sensitivity. Since at least some of the nodes in the neighborhood of a transmitting node will be receiving at a low sensitivity, the number of nodes decoding the packet is reduced and energy is conserved.

Every time that an inactive sensor node awakes, it decides, at block 316, which sensitivity level to use. In one embodiment, the sensor decides to use the “low” sensitivity level with probability “p_{low}”. Thus, in a network with N nodes at any given time in a wake-up period, approximately p_{low}×N nodes will be operating with the “low” sensitivity level and (1−p_{low})×N nodes with the “high” sensitivity level.

Every time that a sensor becomes active to transmit a packet (or to forward a packet), as depicted by the positive branch from decision block 304, it initially transmits the packet with transmit power level “low” at block 306. The transmission protocol may be an ACK-based protocol in which all transmissions between sensors are acknowledged.

When transmitting at the “low” transmit power level, only those nodes that have selected to use the “high” sensitivity level expend energy to decode the message. Other nodes do not expend this energy. In this manner, only a subset of the nodes will treat the message and so energy is conserved.

In one embodiment, sensors adjust their p_{low} parameter (the probability of selecting a low sensitivity) such that there is enough connectivity in the network when transmitting nodes use the low transmit power level. This enables transmitting nodes to transmit using the low transmit power level since there is likely to be at least one of its neighbors (with a route to the sink node) using the “high” sensitivity level. Maximum energy is conserved when only one of such neighbors is using the “high” sensitivity level.

If transmission fails (or if it fails after a certain number of retransmissions at the “low” transmit power level), as depicted by the negative branch from decision block 308, the sensor would retransmit the packet with transmit power level “high” at block 310. When transmitting at the high power level, the transmitting sensor will ensure that multiple neighbors to treat the message, ensuring that it is forwarded to the sink node. If sensors choose a suitable level for the “p_{low}” parameter, the probability of having sensors having to retransmit at the “high” power level is small.

In order to allow sensors to determine whether their “p_{low}” parameter is suitably set or not, an adaptation process may be used. In one embodiment, the adaptation process is based on the ratio of high-powered retransmissions seen in the past. For this purpose, the packet frame format may include an indication of the power level of the transmission.

In one embodiment, a node may perform the adaptation process as follows. When the network is initially deployed, all nodes may start with a small value for p_{low} (e.g. 0.01). As time passes, nodes adapt the p_{low} parameter to obtain value suitable for the current environment. For example, whenever a packet is received, the sensor node records whether the packet was transmitted using the “high” or “low” power level. Periodically, the node evaluates whether it should increase or decrease p_{low}. If there are too many transmissions at high power levels, the node may decrease the probability of selecting a low sensitivity (or, equivalently, increase the probability of selecting a high sensitivity). For example, if more than 5% of the received packets were transmitted with “high” transmit power level, the node reduces p_{low} (by a factor or selected amount); otherwise, it increases p_{low}. With this procedure, sensor nodes autonomously converge to a level of p_{low} such that the transmissions occur at “low” power level 95% of the times.

Additionally and alternatively, nodes may adjust the value of the “high” and “low” transmit power levels and “high” and “low” sensitivity to its particular situation; in which case, each node could in effect have different transmit power levels or different sensitivity levels. In other words, the “high” transmit power level of one node 600 may be different than the “high” transmit power level of another node; similarly, the “low” sensitivity level of one node may be different from the “low” sensitivity level of another node. However, in all nodes, the “high” transmit power level are higher than the “low” transmit power level and the “high” sensitivity level is more sensitive than the “low” sensitivity level. To perform such adjustment, nodes either exchange control messages or collect statistical information, such as the number of times that it has received transmitted messages at a certain sensitivity level, and use such statistical information in the adjustment.

Another possible adaptation procedure is one in which sensor nodes monitor the activity of nearby nodes and observe whether a received packet was also received by a nearby sensor node. In this approach, sensor nodes would reduce p_{low} if it notices that a high percentage of packets are not being received and vice-versa. In another possible adaptation procedure, nearby sensor nodes exchange messages to coordinate the times in which they can use “low” or “high” sensitivity levels.

Energy savings of 25% or more may be achieved by the above methods.

Although the invention has been described in the context of a wireless sensor network (WSN), it can also be used in a mobile ad hoc network context. For example, inactive nodes of the network would follow the same procedure as described above. However, whenever a node wants to page a specific inactive node, it transmits at high transmit power level, which guarantees the reception by the specific inactive node even if it wakes up using a low sensitivity level.

If transmit power level adaptation is used without reception sensitivity adaptation, the number of sensors handling a transmission is directly dependent on the transmit power level used. Therefore, in order to reduce the number of sensors handling a transmission, the transmit power level must be reduced. This, in turn, means that the hop range is reduced as well, meaning that on average more hops would be necessary to communicate between nodes. Additional hops require additional energy consumption.

When reception sensitivity is adapted, as described above, the number of sensors handling a transmission is reduced and hop range is maintained.

FIG. 4 shows a diagrammatic representation of an exemplary network in accordance with some embodiments of the present invention. In FIG. 4, a message is sent from a transmitting node ‘T’ (400). In this example the transmitting node 400 is transmitting at a low power, so the message is received and decoded by the receiving nodes ‘R’ (402) within the neighborhood 406. Any node that has selected a ‘high’ sensitivity level received and decodes the message. However, other nodes 404 in the neighborhood have selected a ‘low’ power, and the received signal strength at these nodes is such that these nodes do not become active. Thus, the hop-range of the neighborhood is largely unchanged. However, the number of receiving nodes 402 is reduced and so energy consumption is reduced.

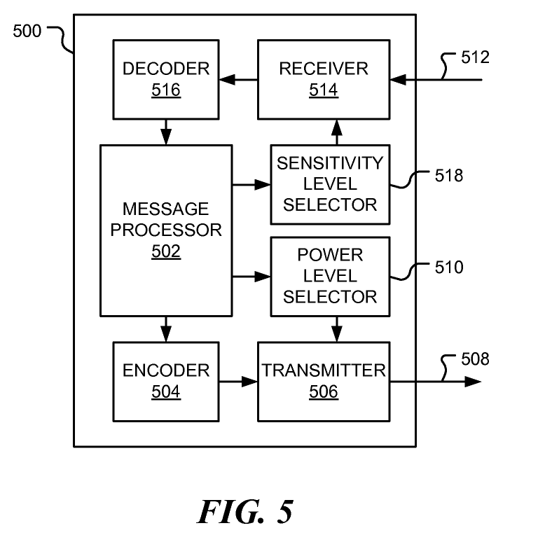

FIG. 5 is a block diagram of an exemplary network node in accordance with some embodiments of the present invention. The network node 500 includes a message processor 502. If the node is a transmitting node that has a transmission capability, it has an encoder 504 and a transmitter 506. The transmitter 506 has at least first and second power levels and is capable of transmitting a message 508 at either of the first and second power levels. A transmitting node also has a power level selector 510 that is operable to select between the first and second power levels. If the node is a receiving node capable of receiving a message 512, it has a receiver 514 having first and second sensitivity levels and a message decoder 518. The message decoder may be activated (awake), to enable decoding of a message, or deactivated (asleep). The decoder consumes less power when asleep than when awake. If the node is a receiving node, it also includes a sensitivity level selector 510 that is operable to select between the first and second sensitivity levels in accordance with a selection scheme. The receiver 514 is operable to sense the strength of the received signal 512 and the decoder 516 of a receiving node is activated to decode a message 512 only if the received signal strength is above the sensitivity level selected by the selector 518.

A node 500 may be capable of transmission, reception, or both transmission and reception. A network includes both transmitting nodes and receiving nodes. Some or all of the nodes may be capable of both transmission and reception.

It will apparent to those of ordinary skill in the art that a node may contain functional elements, such as power supplies, antenna, and sensing elements, in addition to those shown in FIG. 5.

By way of example, a simplified model is used to estimate some of the benefits of the invention. For this model, it is assumed that N nodes are regularly distributed in an area monitored by a single sink node.

It is further assumed that each node has N_{neigh} (six, for example) neighbors, equally spaced such that they can communicate if the receiving node uses the “high” sensitivity level and the transmitting node uses the “low” transmit power level. If the receiving node is at the “low” sensitivity level, the packet can only be received if the transmitting node is a neighbor node and transmits at the “high” transmit power level.

In between two consecutive wake-up periods, it is assumed that 0 or 1 events occur in the circular area being monitored and assume that just one sensor will report the occurrence of this event through a broadcast message.

Any node receiving this broadcast message needs to decode and retransmit the message. Any other sensors receiving a re-broadcast message would, in turn, re-broadcast the message until a maximum number of retransmissions has been reached (or until the sink node receives it).

In order to derive a lower bound for the benefit, it is assumed that just one re-broadcast is required. However, for large areas, several re-broadcasts would be required and the “flooding” of re-broadcasts would impact a much higher number of nodes, meaning that the present invention would have an even higher benefit than reported below.

Assuming a randomly chosen node S1 is inactive in wake-up period k (i.e., S1 has not detected any event before the wake up period). In the baseline, and considering the 1-retransmission lower bound, the expected energy consumed by the sensor S1 during the wake-up period is given by equation (1) below (channel errors and retransmissions are disregarded) where q is the probability that an event happens in the system, γ is the probability that the sensor that captured this event is one of the neighbors of S1, i.e., γ=N_{neigh}/N, e_{forward} is the energy to needed to decode and forward the packet and eₛₑₙₛₑ is the energy consumed to simply sense the channel

E{e_{wout}[k]}=(q·γ)(e_{foward})+(1−q·γ)eₛₑₙₛₑ (1)

In accordance with an embodiment of the present invention, when an event occurs in a node near node S1, it would receive and forward the packet in four situations:
(a) if the node S1 wakes up using the high sensitivity level, the event happens in a node inside the circle of high sensitivity and the transmitting node uses the low transmit power level;
(b) if the node S1 wakes up using the high sensitivity level, the event happens in a node inside the circle of high sensitivity and the transmitting node uses the high transmit power level;
(c) if the node S1 wakes up using the low sensitivity level, the event happens in a node inside the circle of low sensitivity and the transmitting node uses the low transmit power level; and
   (d) if the node S1 wakes up using the low sensitivity level, the event happens in a node inside the circle of low sensitivity and the transmitting node uses the high transmit power level.

The expected energy used is

$$E \{ {e}_{with} [ k ] \} = {\sum }_{s = \{ a , b , c , d \}} E \{ {e}_{with} [ k ] \vert situation = s \} P \{ situation = s \} \qquad ( 2 )$$

Since situation (a) is the same as the baseline scenario, the expected energy consumed at situation (a) is equal to equation (1). In situation (b), given the higher power lower at the transmitting sensor, the actual sensing region is larger, and the expected energy consumed at situation (b) would be given by equation (1), with a higher forwarding energy e_{forword}*due to the higher transmit power consumed and γ=N*_{neigh}/N, where N_{neigh}* is the number of neighbors that can be reached when the transmitter uses high power level. Obviously N_{neigh}*>N_{neigh}.

In situation (c), given the simplifying assumption that the nodes are regularly spaced with a distance that doesn't enable communication when the receiver is at the low sensitivity level and transmitter using low power level, node S1 would not receive the packet in situation (c) and the expected energy consumed would simply be E{e_{wout}[k]|situation=c}=eₛₑₙₛₑ.

In situation (d), given the simplifying assumption that nodes at low sensitivity level can only receive packets from its immediate neighbors, the expected energy consumed at situation (d) would be given by equation (1) with the original γ and higher forwarding energy e_{forword}*.

E{e_{with}[k]|situation=a}=(q·γ)(e_{forward})+(1−q·γ)eₛₑₙₛₑ

E{e_{with}[k]|situation=b}=(q·γ*)(e*_{forward})+(1−q·γ)eₛₑₙₛₑ

E{e_{with}[k]|situation=c}=eₛₑₙₛₑ

E{e_{with}[k]|situation=d}=(q·γ)e*_{forward})+(1−q·γ)eₛₑₙₛₑ (3)

The probability of each situation is given by:

P[situation=a]=(1−p_{low})(1−Pᵣₑₜₓ)

P[situation=b]=(1−p_{low})Pᵣₑₜₓ

P[situation=c]=p_{low}(1−Pᵣₑₜₓ)

P[situation=d]=p_{low}Pᵣₑₜₓ (4)

where Pᵣₑₜₓ is the probability that the transmitter of the event is retransmitting its transmission. This probability is not considered in equation (1) because there are always N_{neigh} neighbors when the method the invention is not used. With the present invention, it may happen that all neighbors of a sensor transmitting an event choose the low sensitivity level and this would cause the transmitter to transmit in the next wake-up period at high power level. Therefore, Pᵣₑₜₓ is given by:

$${P}_{retx} = {\prod }_{i = 1}^{{N}_{neigh}} {p}_{low , i} \qquad ( 5 )$$

Considering all nodes at same p_{low} value and considering N=100, N_{neigh}=6, N_{neigh}*=19, p_{low}=0.61, which gives Pᵣₑₜₓ=0.05, and considering e_{forward}*=2e_{forward}, the benefit of the invention may seen be quantified by the expression

$$\frac{E [ {e}_{wout} ] - E [ {e}_{with} ]}{E [ {e}_{wout} ]} .$$

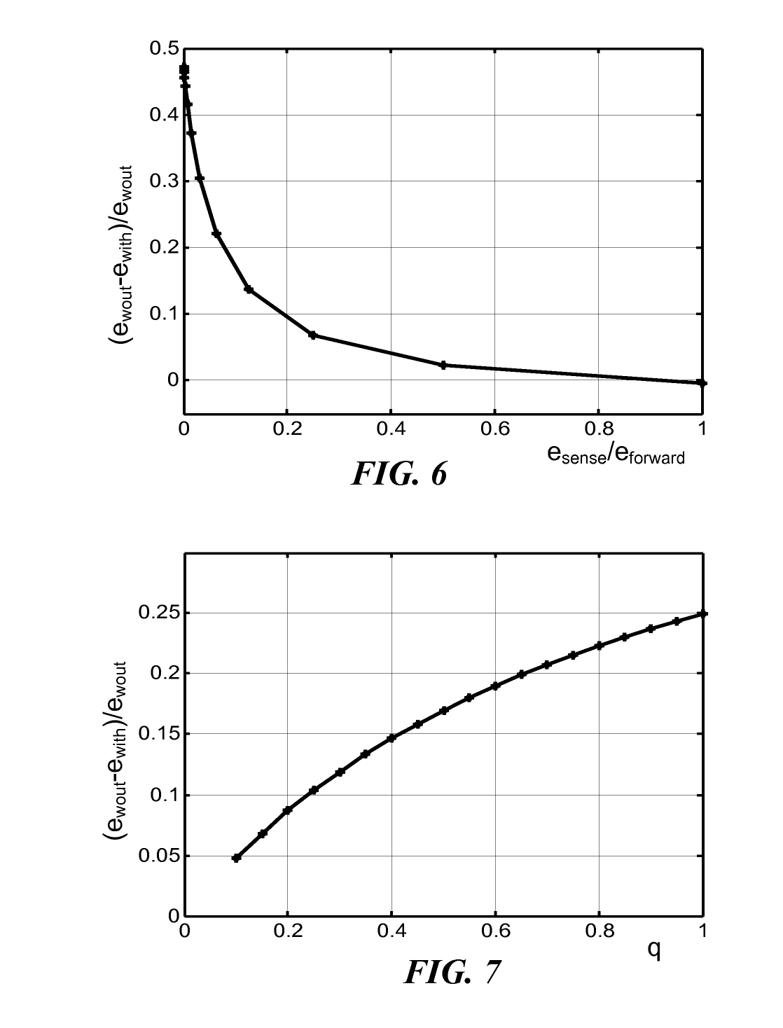

FIG. 6 is a plot of the benefit, for q=1, as a function of the ratio eₛₑₙₛₑ/e_{forward}, of the sensing energy level to the forwarding energy level. More benefit is obtained at lower values of the ratio. This is significant, since many networks attempt to lower the value of eₛₑₙₛₑ/e_{forward}. For example, if a CSMA access procedure is executed in nodes that forward a packet, it is expected that e_{forward}>>eₛₑₙₛₑ. In the IEEE 802.11 wireless protocol standard, a node that wakes up would need to monitor the channel, run back-off procedures and wait for other transmissions in order to forward its packet. Thus, it would not be surprising to find eₛₑₙₛₑ/e_{forward}=0.05. In this case, the present invention would give a benefit of 25%, according to the simple model described above. This may be considered a lower bound, since the model only considered the energy savings in a one-rebroadcast scenario.

As the event generation rate drops (i.e. as q goes toward 0), the invention benefit reduces as well, this is clear since when events don't happen, the invention and baseline behaves the same.

FIG. 7 is a graph showing the benefit of an embodiment of the invention for the ratio eₛₑₙₛₑ/e_{forward}=0.05 as a function of the event generation rate, q.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for reducing energy consumption in a network, the method comprising:
a first node of the network transmitting a message at a first power level;
the first node determining if the message is received by a neighboring node of the network;
the first node retransmitting the message at a second power level, higher than the first power level, if the message is not received by a neighboring node of the network;
a second node of the network, in a neighborhood of the first node, selecting a receiver sensitivity level from at least first and second receiver sensitivity levels;
the second node sensing a received signal strength of the message; and
the second node activating an energy-consuming functional element to decode the first message only if the received signal strength is above the selected receiver sensitivity level.

2. A method in accordance with claim 1, wherein the second power level used by the first node transmitting the message is such that the received signal is above both the first and second receiver sensitivity levels.

3. A method in accordance with claim 1, wherein the first power level used by the first node transmitting the message is such that the received signal strength is above the first receiver sensitivity level and below the second receiver sensitivity level.

4. A method in accordance with claim 1, wherein the second node of the network selects the receiver sensitivity level upon leaving a low power state and entering a higher power state.

5. A method in accordance with claim 1, wherein decoding the message comprises decoding a network destination address, the method further comprising:
the second node of the network forwarding the message in accordance with the network destination address if the received signal is above the selected receiver sensitivity level.

6. A method in accordance with claim 1, wherein the message comprises a request for routing information.

7. A method in accordance with claim 1, wherein the network comprises a wireless sensor network and wherein the message comprises event data collected by a sensor.

8. A method in accordance with claim 1, wherein the first node determining if the message is received by a neighboring node of the network comprises the first node listening for an acknowledgement message from a neighboring node.

9. A method in accordance with claim 1, wherein the first node determining if the message is received by a neighboring node of the network comprises the first node listening for the rebroadcast of the message by one of its neighbors.

10. A method in accordance with claim 1, wherein the receiver sensitivity level is selected at random.

11. A method in accordance with claim 1, wherein selecting a receiver sensitivity level is performed by a process that is adapted dependent upon the number of high-powered retransmissions relative to the number of low-power transmissions.

12. A method in accordance with claim 1, wherein selecting a receiver sensitivity level and transmit power level are performed by a process that is adapted based on control messages exchanged with other nodes.

13. A method in accordance with claim 1, wherein selecting a receiver sensitivity level and transmit power level are performed by a process that is adapted based on statistical information collected from measurements over a period of time.

14. A method in accordance with claim 1, further comprising:
the second node exchanging messages with neighboring nodes to determine if a received message was also received by a neighboring node; and
the second node coordinating selection of its receiver sensitivity level with the neighboring nodes.

15. A network comprising:
a transmitting node comprising:
a message processor operable to generate a message;
a transmitter having first and second power levels and being capable of transmitting the message at either of the first and second power levels; and
a power level selector to select between the first and second power levels; and
a receiving node comprising:
a receiver having first and second sensitivity levels;
a sensitivity level selector to select between the first and second sensitivity levels in accordance with a selection scheme;
a decoder;
wherein the decoder of the receiving node is activated to decode a message received by the second node only if a signal strength of a received message is above the sensitivity level selected by the sensitivity level selector.

16. A network in accordance with claim 15, wherein the receiving node further comprises a transmitter capable of forwarding the received message if the signal strength of a received message is above the sensitivity level selected by the sensitivity level selector.

17. A network in accordance with claim 15, wherein the transmitting node transmits a message at the lower of the first and second power level unless a prior message transmitted at the lower power is not acknowledged by any neighboring node.

18. A network in accordance with claim 15, wherein the sensitivity level selector selects the sensitivity level in accordance with a random process.

19. A network in accordance with claim 15, wherein the selection scheme of the sensitivity level selector is adapted dependent upon the number of high power messages and low power messages.

20. A network in accordance with claim 15, wherein the first and second power levels of the power level selector are adapted dependent upon the number of low power messages acknowledged by neighboring nodes.

21. A network in accordance with claim 15, wherein the first and second receiver sensitivity levels and the first and second transmit power levels are adapted dependent upon control messages exchanged between nodes.

22. A network in accordance with claim 15, wherein the first and second receiver sensitivity levels and the first and second transmit power levels are adapted dependent upon statistical information from measurements collected over a period of time.

23. A network in accordance with claim 15, wherein the network comprises a wireless sensor network and the transmitting node further comprises a sensor linked to the message processor.
